(19) United States
(12) Patent Application Publication
(10) Pub. No.: US 2007/0029907 A1
(43) Pub. Date: Feb. 8, 2007

(54) High-pressure discharge lamp with reflector and cooling device

(75) Inventors: Edmond Mariette Emile Verstraeten, Geel (BE); Dave Chris Paulina Louis Van Duppen, Dessel (BE); Wouter Jozef Maes, Zwijndrecht (BE); Jens Pollmann-Retsch, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/556,004

(22) PCT Filed: May 3, 2004
(86) PCT No.: PCT/IB04/50559

§ 371 Date: Nov. 8, 2005

(30) Foreign Application Priority Data
May 12, 2003 (EP) 03101314.7

(51) Int. Cl. H01J 61/52

(52) U.S. Cl. 313/35

(57) ABSTRACT

A high-pressure discharge lamp with a reflector (2) and a cooling device is de-scribed wherein the cooling device consists of at least one pair of nozzles (7) which guide a cooling gas flow (8) onto the electrode lead-through of the discharge tube (3).

The invention relates to a compact high-pressure discharge lamp with a reflector and a cooling device, suitable for use in projection devices.

It is known that high-pressure gas discharge lamps (HID [high intensity discharge] lamps) and in particular UHP (ultra high performance) lamps are used by preference inter alia for projection purposes because of their excellent optical properties.

A light source which is as point-shaped as possible is required for these applications, because the luminous discharge arc generated between the electrode tips must not exceed a length of approximately 0.5 to 2.5 mm. Furthermore, as high as possible a luminous intensity is desired in combination with a spectral composition of the light which is as natural as possible.

These properties can be optimally obtained with UHP lamps. Two essential requirements, however, must be simultaneously fulfilled in the development of these lamps.

On the one hand, the highest temperature of the discharge tube must not become so high that devitrification occurs. This is true in particular for the upper side of the lamp, because the strong convection inside the discharge tube of the lamp always heats the region above the discharge arc particularly strongly.

On the other hand, the coldest spot at the inner surface of the discharge tube (burner space) must still have a temperature so high that the mercury does not deposit there, but remains in the vapor state in a total quantity which is sufficient

These two mutually conflicting requirements have the result that the maximum admissible difference between the highest and the lowest temperature (generally at the upper and at the lower inner side of the discharge tube) is comparatively small. The inner convection, however, mainly heats the region above the discharge tube and the temperature thereof can only be reduced within narrow limits through a suitable shaping of the lamp bulb, with the result that it is comparatively difficult to keep within the maximum difference, and narrow limits are imposed on a power increase of the lamp.

Finally, said requirements often also present a problem when the light output of the lamp is to be dimmed, because this leads in most cases to a cooling-down and condensation of the gas, and thus to an impairment of the spectral and photometric properties of the generated light.

It is accordingly an object of the invention to provide a high-pressure discharge lamp for projection purposes whose spectral and photometric properties render it particularly suitable for use in projectors. 10 The UHP lamps suitable for projectors, which are usually operated at powers of 100 W and above, are known from U.S. Pat. No. 5,109,181. Both the discharge tube and the tungsten electrodes are very strongly heated therein. To avoid the risk involved therein of a recrystallization of the quartz, the German patent application DE-OS 101 00 724.8 proposes a high-pressure gas discharge lamp with a cooling device which prevents a devitrification of the lamp bulb and a condensation of the filling gas substantially also at the increased power of the lamp. In this case, the hottest parts of the discharge tube, which are usually found at the upper side of the quartz burner, are cooled more strongly, whereas the lower, cooler parts of the discharge tube are essentially not cooled, because otherwise the mercury vapor pressure in the lamp would be lowered. A high mercury vapor pressure, however, is one of the essential preconditions for a high-power UHP lamp.

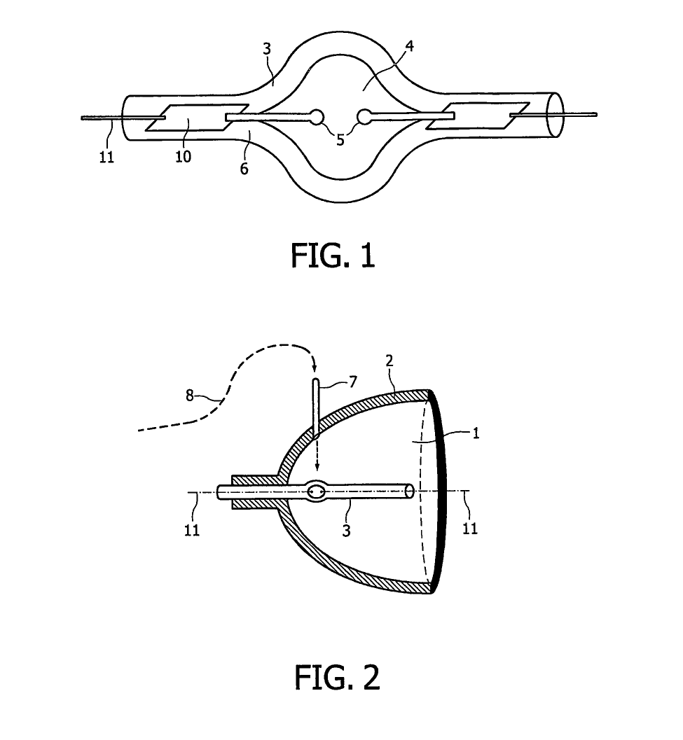

FIG. 1 shows the construction principle of a UHP lamp. A filling of mercury and additives and two tungsten electrodes 5, between which a discharge arc is formed during lamp operation, are present in the inner space 4 of the discharge tube 3. The inner space 4 of the lamp must be closed in a gastight manner against the surroundings if the high gas pressures in the inner space 4 of the lamp necessary for an efficient lamp operation are to be achieved. For this purpose, an electrically conductive molybdenum foil 10 is fused or pinched into the quartz of the discharge tube 4. The electrodes 5 are connected to the molybdenum foil 10. The electrical supply of the lamp takes place through external leads 11. The tungsten electrodes are in direct contact with the quartz of the discharge vessel 3 in the regions of the electrode lead-throughs 6.

The German patent application 102 31 258.3, furthermore, proposes a discharge lamp with a cooling device which is particularly suitable for a high-pressure gas discharge lamp. A special arrangement of the nozzles provided for the introduction of cooling air renders it possible to reduce the temperature of the discharge tube to such an extent that damage to the quartz glass does not occur, while at the same time a sufficiently long lamp life is safeguarded. The dimensions and positions of the nozzles are chosen such that light losses caused by blocking of the light path are excluded as much as possible. This cooling system renders it possible to operate discharge lamps with powers above 300 W and with mercury vapor pressures above 200 bar. Such lamps supply a sufficient amount of light for modem projection applications with high requirements imposed on the luminous flux, such as electronic light image displays or digitally controlled floodlights.

Although the problem of quartz recrystallization of the discharge tube can be solved with the proposed cooling devices in the lamps described, another problem remains unsolved, i.e. a problem arising from the high temperature of the hot plasma arc, which may rise to above 8000 K: the high temperature heats up the tungsten electrodes so strongly that they burn off at an increased rate, whereby the total achievable luminous efficacy of the discharge arc is reduced. A reduced life of the discharge lamp is the undesirable result.

To counteract the above disadvantages, a new cooling device was developed for the high-pressure discharge lamp according to the invention. The cooling device here comprises at least one pair of nozzles 7 which guide a cooling gas flow 8 towards the electrode lead-throughs 6 of the discharge tube 3. An external cooling of the electrodes via these regions of the discharge tube 3 is particularly effective because a very good coupling between the electrodes and the outer space is present there.

The lamp body is closed in a gastight manner at the electrode lead-throughs 6 so as to render possible a high mercury vapor pressure inside the lamp body. There is accordingly a close contact between the hot tungsten electrodes and the surrounding quartz body there. Accordingly, an effective cooling of the electrodes is achievable, and it is possible with the cooling device according to the invention to reduce the temperature of the electrode lead-throughs and the electrodes considerably, so that the useful life both of the electrodes and also of the quartz body is prolonged.

The invention will be explained in more detail with reference to the drawing, in which:

FIG. 1 shows the construction principle of a UHP lamp;

FIG. 2 diagrammatically shows a cooling device for a high-pressure discharge lamp according to the prior art from the German patent application 102 31 258.3;

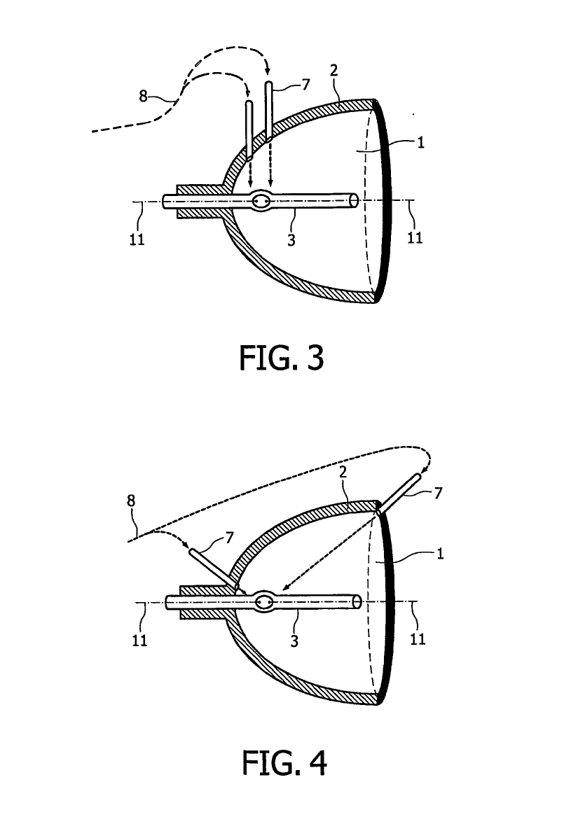

FIG. 3 diagrammatically shows the cooling device according to the invention for a high-pressure discharge lamp;

FIG. 4 shows the cooling device according to the invention, in which one or several nozzles are arranged in front of the reflector;

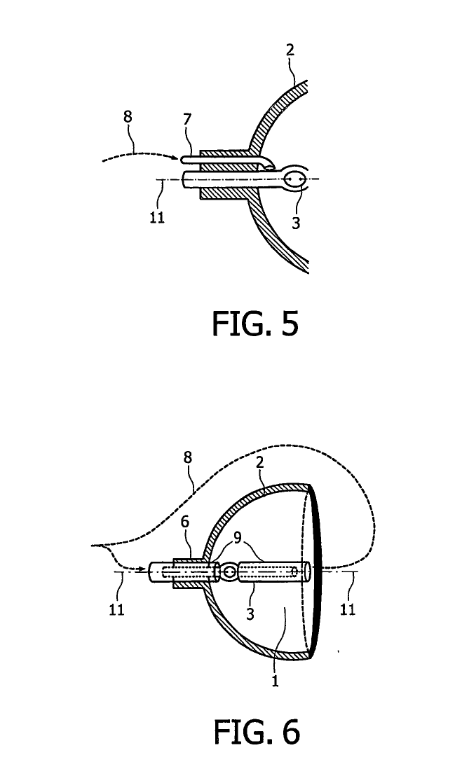

FIG. 5 shows the cooling device according to the invention, in which one or several nozzles are arranged in the reflector neck;

FIG. 6 shows a cooling system according to the invention in which the electrode is surrounded by two sleeve portions into which cooling gas flows can be blown from mutually opposed directions; and

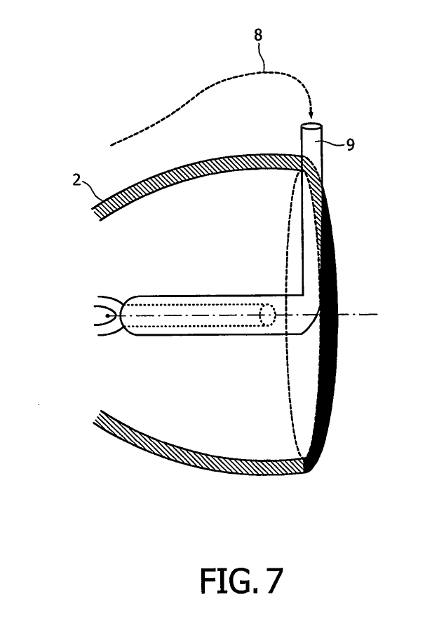

FIG. 7 shows the gas supply to the sleeve-type cooling nozzle facing the reflector opening.

FIG. 2 shows the cooling system for a discharge lamp as proposed in the German patent application 102 31 258.3. This cooling system already provides a discharge lamp 1 whose power, efficiency, and luminous efficacy can be significantly enhanced, while at the same time already a considerable lengthening of the life of the discharge lamp is achieved. A gas flow 8 is aimed at the discharge tube 3 here, and at least one nozzle 7 is arranged such that it does not extend into a radiation path generated by the lamp or the reflector 2. Neither the luminous efficacy nor the radiation characteristic of such a lamp is adversely affected by the cooling device thus provided.

By contrast, according to the invention, FIG. 3 shows that not just one nozzle, but at least one pair of nozzles 7 is used, guiding a cooling gas flow 8 not against the hottest portion of the discharge tube 3, but against the electrode lead-throughs 6 of the electrode. For this purpose, the two nozzles of the nozzle pair 7 are passed through the reflector 2 at a mutual distance of less than 1 cm. Light losses through blocking of the radiation path are avoided by the cooling device according to the invention as much as by the cooling system disclosed in the German patent application 102 31 258.3. In addition, the superposition of the two gas flows 8 from the two nozzles 7 is capable of generating turbulent gas flows which cool the upper portions of the electrode lead-throughs 6 of the discharge tube 3 in a particularly effective manner.

It was possible with such a cooling device to prolong the envisaged life of the tungsten electrodes 5 considerably and to reduce the electrode temperature considerably.

A special embodiment of the invention is obtained when several nozzle pairs 7 are included in the reflector 2 such that the particularly hot upper sides of the electrode lead-throughs of the discharge tube 3 are always cooled more strongly. This is useful, for example, when the discharge lamp is used in projection systems which are designed for several operational orientations (for example stand and ceiling mounting).

To control the high thermal load of discharge lamps evenly and to avoid high peak loads, the German patent application 021 02 727.1 proposes a discharge lamp in which certain operational parameters, such as current strength, lamp power, pressure, and/or flow of the cooling gas, are automatically controlled. A control unit is used for this purpose, for controlling the lamp driver and/or the cooling device at least during the switch-on or switch-off phase of the discharge lamp, ensuring that a given range of one or several operational parameters is not departed from. Such a control of the operational parameters may be highly advantageously used also for the high-pressure discharge lamp according to the invention.

The object of the present invention, i.e. of guiding a cooling gas flow to the electrode lead-throughs of the discharge tube, however, may obviously also be achieved through an alternative arrangement of the nozzles 7 with respect to the lamp 1. Thus it may be advantageous to choose a nozzle arrangement as shown in FIG. 4. Here one nozzle 7 is arranged in front of the reflector 2, and thus does not interfere with the light path. The other nozzle 7 is arranged in the vicinity of the reflector neck, whereby again the optical power of the reflector 2 is not impaired. An effective cooling of the electrode lead-throughs of the discharge tube 3 can be achieved also with this special arrangement.

Another advantageous arrangement of the nozzles is found when one of the nozzles 7 is directly introduced into the reflector neck, as shown in FIG. 5. In this case the shape of the nozzle 7 must be somewhat modified so as to ensure that the gas flow 8 will hit the electrode lead-throughs 6 of the discharge tube 3.

The nozzles 7 should have a diameter of approximately 0.5 to 2 mm in each of the embodiments described and should be connected to a gas pressure source capable of generating a gas pressure of several hundreds of mbar in the nozzles.

Another embodiment of the discharge lamp according to the invention is shown in FIG. 6. Here the two nozzles cooling the electrode lead-throughs of the discharge tube 3 are constructed as sleeve sections 9 which surround the discharge tube 3. The cooling gas 8 is blown into these sleeve sections 9 from either end, thus surrounding the discharge tube 3 on all sides. It is particularly advantageous, however, if the axis of the discharge tube 3 within the sleeve sections 9 is positioned such that a stronger air flow can be passed along those portions of the electrode lead-throughs 6 that become particularly hot, in comparison with the air passed along the lower portions of the electrode lead-throughs. This may be achieved in that the discharge tube 3 is not centrally arranged in the sleeve portions 9, but shifted downwards. In that way the upper portions of the electrode lead-throughs can be covered by a particularly strong cooling flow of air. The sleeve portions 9 should have a diameter which is some 0.5 to 4 mm greater than that of the discharge tube in the regions of the electrode lead-throughs. Again, the sleeve-type nozzles should be connected to a gas pressure source capable of generating a gas pressure of several hundreds of mbar in the nozzles. FIG. 7 shows how the gas supply can be realized for that nozzle which serves to cool the electrode facing the reflector opening in the case of a sleeve-type nozzle shape. It is to be heeded here that the gas supply should not cause too strong a shadow effect on the light radiated by the lamp. This may be achieved, for example, in that the cross-sectional area of the gas supply is kept small. The use of transparent materials for the gas supply is also conceivable, but in this case possible optical (lens) effects are to be taken into account.

The high-pressure discharge lamp according to the invention in the embodiment described immediately above differs clearly from that with the known cooling system described in relation with a DC discharge lamp in the international patent application WO 00/60643. This patent application describes a sleeve-type nozzle which cools the discharge tube of a vertically positioned DC discharge lamp. The sole nozzle here is provided at the one end of the discharge lamp. The only object of this arrangement, however, is to achieve a cooling of the discharge tube. Special constructions of the anode and the cathode are provided therein for reducing the heat load on the electrodes. Such electrode constructions are usual in DC discharge lamps because a special cooling arrangement for the electrodes can be avoided thereby.

Since the discharge lamps according to the invention are operated on alternating current, however, a special construction of the anode and the cathode is not possible. Instead, both electrodes are to be directly cooled in the discharge lamp according to the invention. Two mutually similar, sleeve-type nozzles as in the embodiment described above are suitable for this. The anode and the cathode may have the same construction here.

A decisive difference of the discharge lamp according to the invention with the arrangement of the international patent application WO 00/60643 is accordingly that it is possible according to the invention to use an AC operation of the high-pressure discharge lamps.

A particularly effective cooling system is accordingly made available for the electrodes of the high-pressure discharge lamp according to the invention, whereby the power and the useful life of such lamps are substantially improved.

### LIST OF REFERENCE NUMERALS

1 discharge lamp
2 reflector
3 discharge tube
4 inner space of discharge tube
5 electrodes
6 electrode lead-through
7 nozzles
8 air flow
9 sleeve sections
10 molybdenum foil
11 outer current lead

In the claims:

1. A high-pressure discharge lamp with a reflector and a cooling device, characterized in that the cooling device comprises at least one pair of nozzles (7) which guide a cooling gas flow (8) onto the electrode lead-throughs (6) of the discharge tube (3).

2. A discharge lamp as claimed in claim 1, characterized in that the pair of nozzles comprises two nozzles (7) which are passed through the reflector (2) at a mutual distance of less than 2 cm.

3. A discharge lamp as claimed in claim 1, characterized in that one or several nozzles (7) are arranged in front of the reflector (2).

4. A discharge lamp as claimed in claim 1, characterized in that one or several nozzles (7) are arranged in the reflector neck.

5. A discharge lamp as claimed in claim 1, characterized in that the discharge tube (3) is surrounded by two sleeve sections (9) into which cooling gas flows (8) can be introduced from mutually opposed directions.

6. A discharge lamp as claimed in claim 5, characterized in that the sleeve sections (9) have a diameter which is 0.5 to 4 mm greater than that of the discharge tube in the regions of the electrode lead-throughs (6).

7. A discharge lamp as claimed in claim 1, characterized in that the cooling power is controlled by a control unit so as to observe given operational parameters.

8. A discharge lamp as claimed in claim 1, characterized in that the nozzles have a diameter of approximately 0.5 to 2 mm.

9. A discharge lamp as claimed in claim 1, characterized in that it is connected to a gas pressure source capable of generating a gas pressure of several hundreds of mbar in the nozzles.

10. A projection system with a high-pressure discharge lamp as claimed in claim 1.
